(19) United States
(12) Patent Application Publication
(10) Pub. No.: US 2011/0059207 A1
(43) Pub. Date: Mar. 10, 2011

(54) BOTANICAL DISPERSIONS

(76) Inventors: Kathy Riker Niness, Berwyn, PA (US); Mark Thomas Izzo, West Chester, PA (US)

(21) Appl. No.: 12/944,409

(22) Filed: Nov. 11, 2010

Related U.S. Application Data
(63) Continuation of application No. 11/370,627, filed on Mar. 8, 2006, now abandoned.

(51) Int. Cl. A23G 1/48; A23G 1/54; A23G 1/36; A23G 3/48

(52) U.S. Cl. 426/93; 426/99; 426/601

(57) ABSTRACT

Dispersions of particulates of botanicals in a continuous phase of fat and food products comprising the same are disclosed.

### FIELD OF THE INVENTION

The present invention relates to food products and to their methods of preparation. More particularly, the present invention provides dispersions of particulates of certain dried botanicals, in a continuous phase of fat and methods of preparing the same.

### BACKGROUND OF THE INVENTION

Several publications, texts and patent documents are cited throughout the present specification to better describe the state of the art to which the invention pertains. Each of these citations is incorporated herein by reference.

Botanical products are ancient foods widely prized throughout the world due to their highly desirable flavor profiles and sought after bioactive effects, and more recently the host of health benefits associated with each. The most widely consumed and important of these botanicals are coffee, tea and wine. The growth and processing of these three types of plant-based foods constitutes a major portion of the food industry, yet each is consumed almost exclusively in the beverage form. In addition to these three beverages, various fruits have been associated with exotic flavors and high levels of health promoting phytochemicals, most notable among these are various berries and pomegranate.

Coffee, one of the most popular drinks in the world, is produced from the beans of two varieties of coffee plants, coffea arabica and coffea robusta. To produce coffee, coffee beans are typically dried and then roasted using hot air. Following roasting, the beans are ground to varying degrees of consistency and the coffee extracted with near boiling water to produce the hot flavorful beverage. Once the coffee beverage is produced, the flavor is manipulated in the beverage format by adding various flavoring agents, e.g., sweetening agents, various forms of dairy to smooth the coffee harshness, and more exotic flavorings such as vanilla, hazelnut, or caramel. Coffee beverage may also be dried, usually employing techniques such as freeze drying and spray drying to produce instant coffee. The artisan skilled in art is well aware of the many methods available for drying fresh brewed coffee to produce instant coffee. However, it is largely accepted by the industry (and the consumer) that all instant coffee products are inferior in taste to their fresh brewed counterparts.

Roasted whole coffee beans have been consumed in various candied forms, e.g., roasted coffee beans coated with chocolate. These products are very harsh in taste as it is difficult to smooth the bitter taste of the whole coffee bean with a relatively thin coating of chocolate. Coffee beans with a coating of caramelized sugar are also known in the art, sometimes referred to as “Torrefacto coffee.” NL 8800618A describes a process for manufacture of torrefacto coffee by roasting green beans, cooling to 25-200° C. and coating with caramelized sugar. WO 0042860 to Winkelmann et al (also published as DE 19902786), teaches a method for candying coffee beans involving roasting in a fluidized bed, adding sugar onto the fluidized bed and then allowing caramelization to proceed. A specified cooling process is then employed so the candies do not stick together. U.S. Pat. No. 6,048,561 issued to Ohtake et al. describes a snack made from at least 12.5-60% roasted ground coffee beans mixed with other grains and water. This mixture is then extruded under heat and pressure to produce a puffed piece. The piece can be subsequently coated with flavors such as sugar, honey, candy, caramel, chocolate or milk.

Coffee in food products other than those described above, mainly comprises a flavoring component of various types of desserts, ice creams and confections. The majority of these food systems are aqueous based. A few are fat based confections such as the use of coffee as a flavoring in various chocolates, and “American truffles”, which are fat based compositions that are mixtures of various types of chocolate, butterfat and coconut oil.

Tea is produced by steeping different varieties of dried ground tea leaves in boiling water. The amount of time the consumer lets the tea leaves steep determines the strength of the resulting beverage. Water soluble portions of tea can be dried to produce instant tea as described above for coffee. However, the many instantizing processes known in the art result in inferior tea beverages when compared to those produced from fresh brewed tea. Tea is rarely found in solid food, and when present is frequently used as a flavoring.

Tea beverages enjoy widespread popularity due to flavor and documented health benefits. For example, the level of antioxidants in tea is quite high and tea beverages have been used to promote weight loss. One disadvantage associated with liquid tea consumption is the difficulty in consuming enough of the product on a daily basis to gain all the associated health benefits.

As early as 1971, the journal Confectionery Production described a truffle containing a tea ganache, a type of aqueous based filling made by stirring chocolate and tea together and heating. (Nyffler E. F., Confectionery Production 1971: 37(5):296,298-300, 309). Nolde S. in a family of German Patent Applications (DE 3821381 A1-3821388 A1) filed in 1990 describes the use of various types of tea extracts alone or in combination with fruit or milk in a variety of aqueous based confections. Applications of the product include pastilles coatings (hard jellylike candies made with gelatin); dragees (sugar based candy balls); and pralines and bonbons (small filled candies usually coated with chocolate or fondant, where the tea extract is incorporated into the aqueous based filling).

Recently, the use of tea extracts in chewing gum has been described for its health promoting (anticancer and weight loss) properties. Mega-T Green Tea Chewing Gum from CCA Industries Inc., is on the market with each piece of gum being equivalent to drinking 2 cups of green tea. WO 9500038, to Ream et al, discloses the addition of tea, coffee beans, instant tea, or instant coffee to a molten candy mass to produce a hard candy or a chewy candy. The patent further teaches the addition of the same products to a gum base to produce chewing gum.

Wine is produced by various fermentation techniques from many different varieties of grapes. The consumer has an ancient love affair with wine, and its sophisticated and complex flavor experiences are widely recognized as one of the great pleasures the culinary world has to offer. However, the use of wine as a solid food has been limited.

There are now wine powders as well as liquid concentrates available that contain no alcohol (Polyphenolics, Madera Calif.). These products are employed as food supplements due to the positive health benefits associated with moderate red wine consumption, e.g., improved heart health. In addition to these newer uses of wine as a health supplement, it has long been used in cooking as a flavoring to make many types of sauces and reductions by gourmet chefs. But its use in prepared foods, other than as a flavoring in certain varieties of gourmet cheeses has been virtually nonexistent.

Wine and other alcoholic beverages have been used to produce frozen confections. U.S. Pat. No. 4,350,712 to Kocharian et al. discloses a popsicle type confection which utilizes either frozen beer or frozen wine mounted upon a stick. Similarly, US patent application 20050142253 discloses a method for production of alcoholic water ices, including wine, by freezing in a mold in a −40 to −30° F. brine solution. The use of wine in a confection is described in ES2231019 to Roque et al. The author discloses an aqueous based confection composed of flour, salt, water, wine, margarine and cream.

Due to the overwhelming popularity of the beverages described above, it would be advantageous to produce a convenient solid food form that delivered the high quality taste experience of a fresh brewed cup of coffee or tea, a glass of wine, or a specific type of fruit to obtain the many health benefits associated with each of these botanicals.

### SUMMARY OF THE INVENTION

In accordance with the present invention, dispersions of particulates of dried botanicals in a continuous phase of fat, as well as food products containing the same are provided, with the proviso that the dispersions contain less than 4.9% non fat cocoa solids. Methods for the preparation of these food products are also disclosed. Particularly preferred dried botanicals for use in the invention include, without limitation, coffee, tea, wine, and health promoting fruit such as pomegranate and blueberry.

In one embodiment of the invention, an improved coffee based food product is provided that delivers the true taste experience of a fresh brewed cup of high quality coffee. Surprisingly, a fat continuous dispersion composed of only coffee, dried milk product and sweetener produces a food with the flavor profile, complexity, and consumer appeal of a gourmet freshly brewed coffee beverage. In a preferred embodiment, sharp melting fats such as tropical oils, hydrogenated vegetable oils, and cocoa butter are employed at levels which are effective to aid in delivering the coffee flavor experience.

An exemplary food product of the invention comprises sweeteners, solid fats, and between about 0.01%-75% botanical material which is present as whole dried botanicals or botanical extracts. The product may optionally comprise dried milk based ingredients such as nonfat dry milk or milk proteins. Concentrated botanical extracts are utilized in a range of 0.01%-10% of the food product composition, most preferably in a range of 1% to 5%, with 2% being particularly preferred. When whole botanicals are utilized (e.g., coffee beans, tea leaves or dried fruit) the product may comprise up to 75% of the botanical in question, Preferably, whole botanicals are present in the range of 4-60%.

Methods for preparing the particulate dispersions described herein are also provided. An exemplary method entails producing a dispersion by forming a paste from the botanical mixed with additional ingredients, and refining this paste to reduce particle size. The refined mass is then mixed at elevated temperatures to develop flavor and texture, a surface active agent and optionally additional fat is added, and the resulting dispersion is cooled and formed to facilitate its incorporation into the final product.

In another embodiment, the refining step described above is carried out as the last step of the process, after the surface active agent and additional fat is added, and directly before cooling and forming the foodstuff.

In an alternative embodiment, the refining step is eliminated completely, and the dried particles used to produce the dispersion are chosen such that the desired finished product texture is achieved.

In another approach, the dispersion can be produced with all ingredients except for the botanical. The botanical is dried and refined separately, and added to the dispersion last so as to facilitate less exposure to heat and processing to maintain the botanical in as close to its native state as possible.

### DETAILED DESCRIPTION OF THE INVENTION

The present invention relates to food products that are dispersions of particulates of dried botanicals, in a continuous phase of fat and to their methods of preparation. Particularly preferred dried botanicals for use in the present invention include, without limitation, coffee, tea, wine, and health promoting fruits such as pomegranate and blueberry. Each of these product constituents, as well as methods for their preparation and use are described in detail below.

Fat-based dispersions of particulates have several advantages as a delivery system for flavor and texture in botanical-containing food products. Such dispersions deliver concentrated nutrition in a convenient, ready to eat, lightweight, stable food product. There is no preparation required as the products are ready to eat. Due to the absence of water, energy and nutrition are concentrated in the food, as are the food's satiating effects. Also, the product exhibits a rather long shelf-life due to the absence of water. The relatively low processing temperature used in preparing the dispersions of the invention facilitates preservation of nutrients and flavors. In addition, these food systems exhibit excellent stability against flavor degradation as the flavor is essentially “locked in” by coating the very low moisture particles with a continuous phase of fat, protecting the flavors from oxidation and volatile loss. The food products disclosed herein possess superior organoleptic advantages when compared to dry powders alone as the fat present in the product provides melt, and mouthfeel, coating the mouth to allow slow dissolving of the foods components. Partitioning of flavors through the fat phase gives rise to a sustained complex flavor experience.

Interestingly, of the most popular botanicals in the food supply; coffee, tea, cocoa, wine, nuts and various types of fruit, only cocoa and nuts are traditionally consumed as a fat based dispersion of dry particulates, namely chocolate and peanut butter. This is because cocoa beans and nuts are unique amongst botanicals in that they inherently contain 50% fat. In essence when a cocoa bean or a peanut is ground, a fat continuous dispersion is formed, where the fat phase is cocoa butter or peanut oil and the particulates are nonfat cocoa solids or peanut solids. By contrast; coffee, tea, wine and fruit are very low in fat, so when dried, a powder is formed which has none of the benefits of the fat based dispersion described above. Dispersions of such dried botanicals can be formed using other fat sources such as hydrogenated vegetable oils, cocoa butter, palm oil, coconut oil, or any other solid fat, as well as liquid oils to produce spread like products. Surprisingly, the dispersions of the invention exhibit similar organoleptic, nutritional, convenience, and stability advantages as those observed in fat containing botanical foods such as chocolate or peanut butter. Forming fat based dispersions from the botanicals described herein (e.g., coffee, tea, wine, blueberry, pomegranate) actually creates new types of foods with superior complex and rich flavor profiles that have widespread consumer appeal. For example a fat based dispersion of tea, sugar, milk and spices produces a rich flavorful food reminiscent of a Chai latte beverage. Similarly, a fat based dispersion of coffee, sugar and milk produces an edible, solid food with a similar but richer flavor impact than a freshly brewed gourmet espresso beverage.

The food products of the invention differ significantly from conventional chocolate-containing food products. For example, all conventional chocolate products are based on the cocoa bean, and contain at least 10% milled cocoa beans in the form of chocolate liquor. It is the cocoa bean that delivers the signature flavor of chocolate. In contrast, the food products of the current invention are based on other botanicals, particularly coffee beans, tea, wine, or various fruit powders. Food products based on these botanicals are novel as it was previously unappreciated that fat based dispersions can be produced from such water based botanicals. The food products of the current invention contain no milled cocoa beans or amounts of milled cocoa beans below those found in conventional chocolate. Surprisingly, these food products are superior in taste to chocolate with flavorings added.

For example, one aspect of the present invention entails the provision of an improved coffee based food that delivers the true taste experience of a fresh brewed cup of high quality coffee. Surprisingly, a fat continuous dispersion composed of only coffee, dried milk product and sweetener produces a food with the flavor profile, complexity, and consumer appeal of a gourmet freshly brewed coffee beverage. This is not intuitive, since coffee is a beverage normally consumed in its aqueous form. Further, the use of sharp melting fats such as tropical oils, hydrogenated vegetable oils, and cocoa butter at the correct levels aid in delivering the coffee flavor experience. Interestingly, it is the presence of the high amounts of cocoa bean solids (chocolate liquor) found in coffee flavored chocolate in combination with the relatively low amounts of coffee flavoring that preclude the current art from providing such an invention. This discovery was arrived at serendipitously by attempting to design solid delivery systems for botanicals such as coffee tea and wine.

The following definitions are provided to facilitate an understanding of the present invention”

The phrase “dried botanical” as used herein refers to any plant part or product of a plant part that has been dried to contain 10% moisture or less.

“Food product” as used herein includes, without limitation, bars, coatings, chips, chunks, dip bar centers, pieces, strips, drops, and inclusions.

A “sweetener” as used herein, includes, without limitation, sucrose, fructose, dextrose, maltose, lactose, dried honey, maltodextrin, corn syrup solids, palatinose, tagatose, trehalose, sucralose, aspartame, saccharin, neotame, stevia, lo han guo/kuo fruit and extracts thereof, dihydrochalcone, thaumatin, glycerizzin, maltitol, sorbitol, erythritol, lactitol, isomalt, polydexrose, inulin, FOS, resistant maltodextrins, or resistant starches.

The phrase “continuous phase of fat” refers to a hydrophobic lipid phase that is uninterrupted around dispersed solid particles, i.e., the dispersed solid particles are coated in fat which is continuous.

The phrase “dairy component” as used herein refers to milk, non fat dry milk, dry whole milk, dry low fat milks, dried cream, whey protein products, cheese powders, dried buttermilk, sweet dairy whey, acid whey, casein or caseinates, or ultrafiltered milk proteins.

A “bioactive” as used herein refers to an agent naturally present in the botanical being processed into the food product of the invention. For example, a bioactive in coffee is caffeine and in tea a bioactive is an antioxidant.

A “surface active agent” as used herein refers to a molecule that has hydrophobic regions and hydrophilic regions capable of reducing surface tension in emulsions or dispersions, and also includes emulsifiers such as lecithin, fractionated lecithins and lecithin derivatives, mono and diglycerides, or polyglycerol polyricinoleate.

A “fortificant” refers to a vitamin, mineral, protein, peptide, bioactive molecule or plant extract added to foods for its desirable nutritional properties.

Preferred botanicals for use in the invention include coffee, tea, wine, blueberry, and pomegranate or any other dried fruit. Additional fruits contemplated for use in the invention include, grapes, currants, bilberry, raspberry, blackberry, gooseberry, strawberry, boysenberry, elderberry, cranberry, huckleberry, persimmon, mango, apple, apricot, cherry, fig, nectarine, peach, pear, plum, pluot, plumcot, quince, Clementine, grapefruit, kumquat, lemon, lime, mandarin, mineola, orange, pummelo, Satsuma, tangerine, ugli fruit, kiwi, sweety, tangelo, olive, canary melon, cantaloupe, casaba melon, Crenshaw melon, charantais, Christmas melon, derishi, galia, honeydew, Kiwano, melon-pear, musk melon, net melon, ogen melon, pepino melon, Persian melon, uzbek melon, santa claus melon, sharlyn, watermelon, sweet melon, papaya, wax melon, winter melon, xigua, banana, avocado, bignay, date, gandaria, jujube, palm, lychee, sapote, nance, rambutan, tamarind, biriba, breadfruit, champedak, cherimoya/anon, pineapple, soursop, morinda, nangka, jackfruit, soncoya, sweetsop, akee, araza, carambola/starfruit, durian, jaboticaba, kepel, ketupa, loquat, mangosteen, rambai, sala, salak, santoli, kechapi, sapodilla, voavanga, alibertia, bael fruit, calabash, cannonball, feijoa, genipap, guava, granadilla, kiwano, monkey bread, passion fruit, pitahaya, sweet granadilla, tomato, chalta, summer squash, cucumber, pepper, and zuchini. When used in powdered form, the moisture content of these botanicals must be below 10%, and is more preferably below 5%. Suitable methods of drying the botanicals to this moisture content include roasting, spray drying, drum drying, freeze drying, vacuum drying, air drying, or oven drying. The botanical plant material itself may be dried, or an aqueous extract of the plant material may be prepared and then dried. An example of this is the use of coffee beans ground to a powder in the dispersion or an instant coffee. The use level of the botanical varies depending on its type as well as on the desired flavor. Generally whole plant botanicals will range from about 2%-75% botanical material present, with higher use levels for fruit and lower for coffee and tea. Preferably, whole botanicals are present in the range of 4%-60% and most preferably in the range from 4%-45%. Concentrated botanical extracts are utilized in a range of about 0.01-10% of the food product composition, most preferably in a range of about 1% to 5%, with 2-3% being particularly preferred.

Sweetener components may be included in the food product of the invention. When present, particularly preferred sweeteners are granular sucrose or fructose. Sucrose is preferred when creating a coffee and tea based product. Fructose is preferred when creating wine and fruit based product. However, any nutritive sweetener may be utilized when creating the food products of the invention and include without limitation dextrose, maltose, lactose, dried honey, maltodextrin, corn syrup solids, and the like. In addition, slowly digested nutritive carbohydrates such as palatinose and tagatose are useful in preparing dispersions which exhibit slow release of energy and lower glycemic index for special populations. Similarly, sugar free and reduced sugar versions of the dispersions of the invention may be produced by selecting sweeteners from the group consisting of at least one of maltitol, sorbitol, erythritol, lactitol, isomalt, polydexrose, inulin, FOS, resistant maltodextrins, or resistant starches, sucralose, aspartame, saccharin, neotame, stevia, lo han guo or kuo whole fruit and extracts, dihydrochalcone, thaumatin, and glycerizzin.

The sweetener component of the dispersion is present at approximately 0-60% wt/wt of the food product, more preferrably in the range of 25% to 50%, most prefenably 40%-50%.

The optional dairy components are preferably milk, either non fat dry milk, dry whole milk, or dry low fat milks, dried cream, or cheese powders. Other sources of dairy solids that may be used include but are not limited to dried buttermilk, sweet dairy whey, acid whey, casein, whey protein concentrate, whey protein isolate, and ultrafiltered milk proteins. The dried dairy component of the dispersion serves the dual function of providing well rounded nutrition in the form of protein and calcium and smoothing and enriching the taste of the product, as well as providing certain “signature flavors” traditionally associated with the way the botanical is currently consumed. The exact form of dairy used depends on the signature gourmet flavor to be developed. For example, milk is preferred when combined with coffee to attain highly desirable cappuccino and latte type flavors to the dispersions, while cheese powders can be used in a dispersion based on wine as the botanical.

The dairy component is optional in the dispersion. For example when the food product is designed to deliver a more pure flavor, e.g., “black coffee”, little or no milk will be added. Other versions of the food product disclosed herein, e.g., a café latte, can contain as much as 45% total milk solids. The total milk solids are preferably present as non fat dry milk and anhydrous milk fat rather than whole milk solids. The non fat dry milk and anhydrous milk fat are preferrably present in the same ratio of milk solids nonfat to milk fat as that found in whole milk, 28% fat to 72% non fat milk solids. This allows maximum availability of the milk fat for flavor, to coat the surface of all the particles in the dispersion, and to reduce viscosity of the dispersion.

Fats for the dispersion will be selected based on the taste, texture, nutritional profile and cost of the desired finished product. Preferably, cocoa butter or fractionated palm oil will be employed as these are completely natural, contain no trans fats, and have a sharp melting point near body temperature that will produce a solid dispersion at room temperature that will melt quickly in the mouth for best flavor release. A disadvantage of these preferred fats is the relatively high cost versus other fat options. Alternatively, hydrogenated vegetable oils may be used, having the advantage of low cost but the disadvantage of being artificial and containing significant amounts of trans fats. Fats will be present in the disclosed food products at between 20 and 40% wt/wt, more preferably in the range of 25wt % to 36 wt % and most preferably at 28-32wt % of the product. Too little fat will cause the dispersion to have a high viscosity in its molten form that will be difficult to process whereas, too much will mask flavor release.

In cases where the dispersions are to be used as spreads, liquid oils may be employed. Suitable oils for this purpose include without limitation, olive, soybean, butterfat/anhydrous milk fat/fractionated milk fat, corn, canola, pumpkinseed, sunflower or any vegetable oil. These products have the advantage of having a healthier consumer perception, and contain less saturated and/or trans fats than their solid fat counterparts.

Optionally, the dispersions described herein may contain a surface active agent or emulsifier. Such agents facilitate formation of the dispersion and include, without limitation, mono and diglycerides, lecithin or lecithin derivatives, or polyglycerol polyricinoleate . These agents are preferably used in the range of about 0-1.0 wt. %, and more preferably are present at approximately 0.5 wt %. The use of the surface active agent allows the fat content to remain in the 28-32% range while exhibiting fluidity when in the molten state. This is useful during processing of the dispersions into various forms and shapes for consumption.

The dispersions disclosed herein may also contain a variety of minor constituents, most notably flavors or nutritional fortificants. Exemplary flavors for this purpose include, for example vanilla and vanillin, cream flavors, cocoa liquor, cocoa extracts and cocoa powders, caramel flavors, toffee flavors and fruit flavors. Typical fortificants to be added include vitamins and minerals including but not limited to iron, B vitamins, vitamin D, vitamin K, folic acid, phosphorus, selenium, chromium, magnesium, calcium, and zinc. Since the dispersion is a fat based composition rich in natural botanical antioxidants, addition of other antioxidants such as Vitamin C, Vitamin E or beta carotene are also encompassed within the scope of the invention. The natural levels of botanical antioxidants can be further enhanced by adding extracts having special nutritional properties. Levels of naturally, occuring desirable bioactives, e.g., caffeine, can also be increased in the dispersions by addition of increasing amounts of the bioactive.

Fat-based dispersions containing coffee are particularly preferred. The quality of coffee must considered when creating the dispersions disclosed herein. Arabica coffee, which is shade grown in the higher elevations of coffee producing regions where a single harvest per year occurs, produces the most flavorful beans. These select beans should be wet processed. However, more economical lower quality robusta beans grown at lower elevations, as well as blends of arabica and robusta which are dry processed may also be used. The use of fresh roasted and ground beans is preferred for the greatest flavor impact and complexity, but pre-roasted and ground beans, or dried versions of coffee extracts may also be used (“instant coffee”). These dried products may be spray dried, freeze dried, or dried by another technique. The selected beans are preferably fresh roasted, ground and incorporated into the fat based dispersion as rapidly as possible to seal in the flavor. This process will prevent volatile flavors from escaping by sealing them into the coffee particle with a coating of fat. In addition, this process protects the coffee particle from oxygen which causes oxidation of desirable fresh flavors and subsequent staling. Roasted ground coffee held at room temperature begins to stale in hours, while coffee incorporated into the fat based dispersions of this invention remains fresh for months.

Both the quality of the bean and the severity of the roast have a profound impact on the quality of the finished product. An unlimited number of flavor combinations may be produced by varying the darkness of the roast and the level of the coffee used in the dispersion. For example, a light “cinnamon” roast may be used at higher levels—8% to 25% to produce a desired flavor, while a darker Italian or french roast (also called simply “espresso”) will produce an excellent flavored dispersion at levels as low as 2-11% wt. %. It should be noted that when highly concentrated aqueous extracts which are then spray dried or freeze dried to form a powder are used, lower levels can be employed e.g., from 0.0001%-5%, to produce lower quality less expensive dispersions.

Fresh roasted coffee beans must be pre-milled before mixing with the other particulates of the dispersion for further processing. A roller mill with chilled rolls to grind the beans without heating helps protect against loss of volatile flavors. Conversely, a mill employing rotating disks may also be employed, such as a burr mill. It is known within the art that the finer the grind, the higher the flavor impact will be, but conventional grinding of dry beans also exposes more surfaces to air allowing volatile flavors to escape and air into the particle to oxidize remaining flavor. A particular advantage of the present invention is that a course grind is performed in this pre-milling stage, thus limiting loss of flavor. The subsequent refining steps achieve a particle size much finer (as low as 20 microns) than any coffee grind used to brew coffee, translating into more surface area to contact the tongue and more intense flavor. Normally all this surface area would create many surfaces exposed to oxygen and thus cause staling of the coffee. However, in this invention, these refining steps are done in the presence of fats, so that as the coffee particle is being reduced in size, it is simultaneously being coated with fat to protect the increased surface area from oxidation.

After premilling of the coffee to reduce particle size to that similar to the other particulates in the blend (100-200 microns), the milled coffee is mixed with sweetener, the milk component and enough fat to form a paste mix that can be refined using a roller refiner or other type of mill. The fat added at this stage is typically 50-70% of the total fat content, but can vary depending on the other components of the dispersion. This mixture may be obtained by using any mixer, such as a hobart, or a ribbon blender, or any typical conche used in the confectionery industry.

The paste mix is refined to produce a particle size of approximately 20 microns, preferably using a typical roller refiner, but any method of particle size reduction may be used. This blend is then mixed at temperatures at least above the melting point of the fat used, and preferably from 130-160° F. for the minimum amount of time needed to properly coat the particulates in the dispersion. This time will depend on the mixing action used. For example, when a hobart type mixer is employed, mixing can be accomplished in as little as 15 minutes. At this point, a surface active agent is added to facilitate formation of the dispersion. After letting the blend mix for approximately 15 minutes to 1 hour, the remaining fat, and any optional flavors are added, thus creating the finished molten dispersion.

Alternatively, the coffee-containing dispersions of the invention may be initially prepared using a dry mix of the coffee, milk, and sugar. An appropriate amount of melted fat is added to this mix which is sufficient to cause formation of a crumbly dough, which is allowed to mix for 15-60 minutes at a temperature above the melting point of the fat, preferably in the range of about 125-160° F. The surface active agent is then added and the product is allowed to mix again until it is fully incorporated. The remaining fat is then added, and the resulting melt is circulated through a ball mill to reduce particle size to desired levels, most preferably below 20 microns. At the final stages of the milling process, any additional flavors or fortificants may be added, thus creating the finished molten dispersion.

In yet another alternative method for preparation of the dispersions of the invention, the steps set forth above are utilized to produce a base dispersion of sugar, milk (optional), surface active agents, fat and any desired flavors or fortificants. Separately, the methods described above can be used to prepare various dispersions using different varieties and roasts of coffee and fat. The base dispersion and any coffee dispersion can then be blended together in different ratios to produce a variety of finished products.

The advantage of this method is that a large amount of a base dispersion could be formed to enhance manufacturing efficiency. This base dispersion could then be m mixed readily with different coffee dispersions to easily product smaller amounts of food product flavors, thus increasing manufacturing flexibility.

An additional advantage of this method is that it may be desirable for flavor generation and moisture reduction to mix the milk and sugar components of the invention for longer at higher temperatures. Making two dispersions separately and then mixing would allow the flexibility to protect the coffee component of the dispersion from excessive heating, and still afford desirable manufacturing flexibility.

Once the molten dispersion is formed using any of the methods discussed above, it can be stored warm in its fluid state for cooling and shaping later. Alternatively and preferably for freshness, it may be cooled to 80-125° F., shaped into its final form, and then further cooled below the melting point of the fat used to facilitate solidification of the dispersion. A third option is to cool the dispersion for storage in the solid form, and then remelt the same at a later time to produce the finished product. The liquid dispersions of the present invention may be deposited into molds, or directly onto a surface, cooled to facilitate solidification of the fat in the dispersion, and removed from the mold or surface. A significant advantage of the current invention is that these types of processes, known in the confectionery industry, can be used to process the dispersions of the invention into an unlimited variety of bars, pieces, chunks, chips, pops, dip bar centers for ice cream novelties or any other shape the marketer desires. Alternatively, the dispersions of the current invention can be used to coat a wide variety of foodstuffs, including but not limited to dry fruit, nuts, bar centers of various types including granola and cereal, baked goods (cookies, cakes, other pastries), pretzels, confectionery centers (such as caramel,nouget, malted milk, ganache and others), ice cream and the like.

The methods described above are readily applied to other botanicals. Various types of tea can be used and have the advantage over coffee that a simple drying process is utilized, rather than a roasting process. Dried tea is relatively stable, so it is not necessary to dry and immediately incorporate the dried botanical into the finished dispersion. To this end, dried, milled teas are readily available from suppliers who normally sell to those blending and bagging teas for beverage applications, and are well suited for use as botanicals to produce dispersions of the current invention.

In yet another aspect of the invention, powdered wine concentrates are available, as well as a wide variety of dried fruit powders. These products have the advantage that they normally do not need to be pre-milled, because they are spray dried products and the spray drying process produces fine particles that are acceptable for blending with the milk and sugar components of the dispersion.

The following examples are provided to illustrate certain embodiments of the invention. They are not intended to limit the invention in any way.

### EXAMPLE 1

A coffee containing dispersion of the present invention is prepared according to the following procedure. Green arabica coffee beans are roasted in a drum roaster to an internal temperature of 400-450° F. resulting in a dark Italian roast characterized by a deep brown/black color. The beans are discharged from the roaster, cooled and ground using a burr grinder to a fine grind (approximately 400 microns). The dispersion is then prepared according to the following formula:

Coffee Dispersion

| ingredients | weight |
|---|---|
| sucrose | 45.3 |
| coffee beans | 4.6 |
| skim milk powder | 19.2 |
| milk fat | 7.4 |
| cocoa butter | 23.0 |
| lecithin | 0.5 |
| | 100.0% |

A dry blend of granular sucrose, ground coffee beans, and whole milk powder is prepared using a low shear mixer. The total milk fat and about 15% of the cocoa butter is now added to produce a wet paste. This paste is then passed through a 3 roll mill 5 times to achieve an average particle size of 20 microns. The resulting powder is placed in a heated low shear mixer with a jacket temperature of 140° F. and mixed for approximately 30 minutes. Lecithin is then added slowly and allowed to mix in for 15 minutes. The remaining 8% cocoa butter is added and allowed to mix for 15 minutes. The dispersion is then cooled to 125° F., removed from the mixer and tempered by conventional methods for cocoa butter. After tempering, the dispersion is poured into molds to produce bars and held at 45° F. for 30 minutes to solidify. Pieces are then removed from the molds by inversion of the mold, and immediately wrapped to maintain flavor. Upon consumption, the product will exhibit the pleasing flavor experience of a fresh brewed cup of coffee.

### EXAMPLE 2

A tea-containing dispersion of the present invention comprising whey protein concentrate as the dairy component is prepared according to the following procedure. Whey protein concentrate rather than milk as the dairy component is employed herein as whey produces a dispersion which is also a good source of protein. A dry chai tea blend is used consisting of black tea, and a chai spice blend including cinnamon, ginger, nutmeg and vanilla bean. The dispersion is then prepared according to the following formula:

Tea Dispersion

| ingredients | weight % |
|---|---|
| sucrose | 39.5 |
| chai tea | 10.0 |
| whey protein concentrate | 20.0 |
| (80% protein) | |
| fractionated palm oil | 30.0 |
| lecithin | 0.5 |
| | 100.0% |

A dry blend of granular sucrose, tea, and whey protein concentrate is prepared using a low shear mixer. The mix is heated while mixing at 150° F. for 2 hours to develop flavor and decrease moisture. The fractionated palm oil is pre-melted at 125° F. in an oven. After 2 hours, the fractionated palm oil is added into the mixer and allowed to mix for about 5 minutes. Lecithin is then added, and allowed to mix for 10 minutes. The resulting liquid course dispersion is cooled to 125° F. for refining. Refining is achieved by re-circulating the course dispersion through a ball mill until an average particle size of 20 microns is obtained. The dispersion is then removed from the mixer and used to coat a granola center. The dispersion coated bars are cooled at 45° F. in a tunnel with air circulation for 15 minutes to facilitate solidification before packaging. Upon consumption, the dispersion imparts a pleasant chai tea flavor to the resulting coated granola bar as well as enhancing the bars nutritional profile with added protein.

### EXAMPLE 3

Wine or fruit-containing dispersions of the present invention may be prepared according to the following procedure. A base dispersion is prepared from sugars, fat, and emulsifier followed by preparation of individual dispersions from wine powder and fat, blueberry powder and fat and pomegranate powder and fat, for example. The base dispersion is then mixed in designated ratios with the individual botanical dispersions to produce the finished product. The base dispersion is prepared according to the following formula:

Base Dispersion

| ingredients | weight % |
|---|---|
| sucrose | 39.5 |
| crystalline fructose | 33.0 |
| hydrogenated vegetable oil | 27.0 |
| lecithin | 0.5 |
| | 100.0% |

A dry blend of granular sucrose, and crystalline fructose is prepared using a low shear mixer. About 23% of the melted fat is then added to produce a wet paste. This paste is then passed through a 3 roll mill 3 times to achieve an average particle size of 20 microns. The resulting powder is placed in a heated low shear mixer with a jacket temperature of 140° F. and mixed for approximately 4 hours. The lecithin is then added slowly and allowed to mix in for 10 minutes. The remaining 8% fat is melted, and added and allowed to mix for 10 minutes. The dispersion is then cooled to 125° F. and held.

The botanical dispersions are prepared according to the following formula:

Individual Dispersions

| ingredients | weight % |
|---|---|
| botanical powder (wine, pomegranate, blueberry) | 66.8 |
| hydrogenated vegetable oil | 33.0 |
| mono and diglycerides | 0.2 |
| | 100.0% |

A mix of the botanical powder, fat, and emulsifier is prepared in a mixer heated to 125° F. by mixing for approximately 30 minutes. The resulting liquid course dispersion is refined by re-circulating the dispersion through a ball mill until an average particle size of 20 microns is obtained. The dispersion is then removed from the mixer and blended with the base dispersion from above according to the following formulas:

| | |
|---|---|
| ingredients | weight % |

Finished Wine dispersion

| | |
|---|---|
| base dispersion | 50 |
| botanical dispersion containing wine | 50 |

Finished Pomegranate dispersion

| | |
|---|---|
| base dispersion | 40 |
| botanical dispersion containing pomegranate | 60 |

Finished Blueberry dispersion

| | |
|---|---|
| base dispersion | 28 |
| botanical dispersion containing blueberry | 72 |

The dispersions are cooled to 100° F. and deposited onto a belt in chips or wafer shapes. The formed pieces are passed through a 45° F. tunnel for 15 minutes to facilitate solidification. The resulting pieces can be consumed as is, used as inclusions in granola bars, or baked into cookies to impart a gourmet wine or fruit flavor impression.

While certain preferred embodiments of the present invention have been described and specifically exemplified above, it is not intended that the invention be limited to such embodiments. Various modifications may be made to the invention without departing from the scope and spirit thereof as set forth in the following claims.

1. A food product comprising dispersions of particulates of botanicals in a continuous phase of fat, with the proviso that said product contains less than 4.9% non-fat cocoa solids.

2. The food product of claim 1, wherein the botanicals are optionally dried and are selected from the group consisting of at least one of coffee, tea, wine, and fruit.

3. The food product of claim 2 wherein said botanical is a fruit selected from the group consisting of at least one of pomegranate, blueberry, grapes, currants, bilberry, raspberry, blackberry, gooseberry, strawberry, boysenberry, elderberry, cranberry, huckleberry, persimmon, mango, apple, apricot, cherry, fig, nectarine, peach, pear, plum, pluot, plumcot, quince, Clementine, grapefruit, kumquat, lemon, lime, mandarin, mineola, orange, pummelo, Satsuma, tangerine, ugh fruit, kiwi, sweety, tangelo, olive, canary melon, cantaloupe, casaba melon, Crenshaw melon, charantais, Christmas melon, derishi, galia, honeydew, Kiwano, melon-pear, musk melon, net melon, ogen melon, pepino melon, Persian melon, uzbek melon, santa claus melon, sharlyn, watermelon, sweet melon, papaya, wax melon, winter melon, xigua, banana, avocado, bignay, date, gandaria, jujube, palm, lychee, sapote, name, rambutan, tamarind, biriba, breadfruit, champedak, cherimoya/anon, pineapple, soursop, morinda, nangka, jackfruit, soncoya, sweetsop, akee, araza, carambola/starfruit, durian, jaboticaba, kepel, ketupa, loquat, mangosteen, rambai, sala, salak, santoli, kechapi, sapodilla, voavanga, alibertia, bael fruit, calabash, cannonball, feijoa, genipap, guava, granadilla, kiwano, monkey bread, passion fruit, pitahaya, sweet granadilla, tomato, chalta, summer squash, cucumber, pepper, zuchini.

4.-29. (canceled)

30. A method for the production of a food product comprising particulates of botanicals dispersed in a continuous phase of fat, said method comprising,
a) blending particulates of said botanical;
b) adding fat to said blended particulates, thereby forming a paste;
c) mixing optionally at elevated temperatures;
d) adding at least one surface active agent and optionally additional fat to liquefy said paste; and
e) cooling and forming said paste into said food product.

31. The method of claim 30 further comprises refining said paste to reduce particle size.

32. The method as claimed in claim 31, further comprising addition of at least one of a flavoring agent, a sweetener, a dairy component, a fortificant and/or a bioactive.

33. The method of claim 32 wherein dispersions containing one or more dry particulates are produced separately and subsequently blended.

34. The method of claim 31, wherein said particle size is reduced via a method selected from the group consisting of roller refining, circulation through a ball mill, air classification milling, grinding of the botanical followed by drying, drying of the botanical followed by grinding,and extraction followed by spray drying

35. The method of claim 30, wherein said food product is deposited onto a mold or a belt or injected into a mold to form a product selected from the group consisting of bars, pieces, chips, chunks, pops, strips, and dip bar centers for ice cream.

36. The method of claim 30, wherein said food product is applied to at least one of a bar center, a pretzel, ice cream, frozen confection, cake, scone, éclair, pastry, turnover, brownies, cookie, doughnut, a savory snack and a confection.

37. The method of claim 30, wherein said product comprises an edible spread.

38.-45. (canceled)

46. The method of claim 30, wherein said botanicals are optionally dried, and are selected from the group consisting of coffee, tea, wine and fruit, or a combination thereof.
